(19) United States
(12) Patent Application Publication
(10) Pub. No.: US 2007/0283543 A1
(43) Pub. Date: Dec. 13, 2007

(54) Process for Producing Multilayer for a Multilayer Electronic Device

(76) Inventors: Masaaki Kanasugi, Toky (JP); Shigeki Satou, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 10/568,826

(22) PCT Filed: Aug. 4, 2004
(86) PCT No.: PCT/JP04/11173

§ 371 Date: May 29, 2007

(30) Foreign Application Priority Data
Aug. 29, 2003 (JP) 2003-306107

(51) Int. Cl. H01G 4/12

(52) U.S. Cl. 29/25.42; 361/321.1; 29/25.41

(57) ABSTRACT

There is provided a process for producing a multilayer for a multilayer electronic device, including a dielectric layer and an electrode layer, which process is improved so as to prevent penetration of an electrode paste into the dielectric layer as well as deformation of the dielectric layer and electrode layer, allow raw material sheets required for producing the respective layers such as an adhesive layer-forming sheet to be used in the form of a roll without problems such as back transfer (offset), and allow a multilayer sheet having an adhesive layer to be produced in the form of a roll without problems such as back transfer (offset). In the process of the present invention, transfer steps (first to third steps) and an adhesion step (fourth step) are successively conducted using a green sheet roll (1), an adhesive layer-forming roll (2) and an electrode layer-forming roll (3) which have respective specific layer structures, to produce a roll (4) of a multilayer sheet (40) having a layer structure composed of a first substrate sheet/a release layer/a print-assisting layer/an electrode-spacer layer/an adhesive layer/a dielectric layer/[an adhesive layer/a release layer/a second substrate layer/a back transfer (offset)-preventing layer].

### TECHNICAL FIELD

The present invention relates to a process for producing a multilayer for a multilayer electronic device, and more particularly, to an improved process for producing a multilayer for a multilayer electronic device, including a dielectric layer and an electrode layer, which is effectively prevented from suffering from penetration of an electrode paste into the dielectric layer and deformation of the dielectric layer and the electrode layer.

### BACKGROUND ART

Laminated ceramic electronic parts such as typically multilayer ceramic capacitors have been generally produced by the following method.

First, a dielectric paste prepared by mixing and dispersing ceramic particles, a binder, a plasticizer and an organic solvent is applied onto an upper surface of a substrate sheet, and then dried to form a ceramic green sheet. Then, a predetermined pattern of an electrode paste is printed on an upper surface of the dielectric layer of the obtained ceramic green sheet and then dried to form an electrode layer. Next, the substrate sheet is peeled off from the obtained laminate to form a multilayer composed of the dielectric layer and the electrode layer. A desired number of the multilayers are laminated on each other and compressed together. The resultant laminate is cut into chip-like pieces to form green chips. Finally, the obtained green chips are successively subjected to removal of the binder therefrom, backing and formation of external electrodes thereon, thereby producing the laminated ceramic electronic parts such as multilayer ceramic capacitors.

In recent years, with the miniaturization of various electronic equipments, electronic parts mounted to the electronic equipments have also been required to have a reduced size and a high performance. Therefore, the laminated ceramic electronic parts such as multilayer ceramic capacitors have been strongly required to increase in number of units to be laminated, and decrease in thickness of the respective multilayers. At the present time, the thickness of the dielectric layer which determines a layer thickness of the multilayer ceramic capacitor is required to be as small as not more than 3 μm, and the number of the multilayers used therein is required to be as large as not less than 300.

However, in the case where an electrode paste is applied onto an upper surface of the very thin dielectric layer by a printing method to form an electrode layer thereon, a binder component contained in the dielectric layer tends to be dissolved out or swelled up with a solvent contained in the electrode paste, so that the electrode paste is oozed and penetrated into the dielectric layer, resulting in problems such as defective short circuit.

To solve the problems, there has been proposed a method of applying the electrode paste onto another substrate sheet by a printing method, then drying the applied paste to form an electrode layer, and then heat-transferring the electrode layer onto the surface of the dielectric layer separately formed (Japanese Patent Application Laid-Open (KOKAI) No. 63-51616 (1988) and No. 3-250612 (1991)). However, the above method has such a problem that the substrate is hardly peeled off from the electrode layer transferred onto the surface of the dielectric layer. Further, in the method, in order to heat-transfer and bond the dried electrode layer onto the surface of the dielectric layer, it is required to apply a high pressure to these layers under a high-temperature condition, so that the dielectric layer and the electrode layer tend to suffer from undesirable deformation, and in the worse case, the dielectric layer tends to be partially broken.

The present applicant had proposed a process for producing a multilayer for a multilayer electronic device which is free from the above problems, and is characterized by forming an electrode layer with a predetermined pattern on an upper surface of a dielectric layer of a ceramic green sheet through an adhesive layer (Japanese Patent Application Laid-Open (KOKAI) No. 2003-097128).

### DISCLOSURE OF THE INVENTION

### Problem to be Solved by the Invention

In order to practice the above production process in an industrially useful manner, a ceramic green sheet, an adhesive layer-forming sheet and an electrode sheet required therefor are used in the form of a roll. However, the rolled sheets tend to have problems such as back transfer (offset) depending upon a layer structure thereof.

Also, the multilayer sheet is obtained by subjecting the above respective sheets to transfer treatment, i.e., a required number of the layers are laminated on each other, and then compressed together to form a laminate. Therefore, it is suitable that the multilayer sheet is previously provided therein with an adhesive layer in view of facilitated lamination of the respective layers. However, in this case, there arises such an inconvenience that the respective sheets cannot be used in the form of a roll unless the problem of back transfer (offset) is solved, similarly to the above conventional methods.

The present invention has been conducted to solve the above problems. An object of the present invention is to provide a process for producing a multilayer for a multilayer electronic device including a dielectric layer and an electrode layer, which process is improved so as to prevent penetration of an electrode paste into the dielectric layer as well as deformation of the dielectric layer and electrode layer, allow raw material sheets required for producing the respective layers such as an adhesive layer-forming sheet to be used in the form of a roll without problems such as back transfer (offset), and allow a multilayer sheet including an adhesive layer to be produced in the form of a roll without problems such as back transfer (offset).

### Means for Solving the Problem

To accomplish the aim, in a first aspect of the present invention, there is provided a process for producing a multilayer for a multilayer electronic device, comprising a dielectric layer of a ceramic green sheet, an adhesive layer and an electrode layer with a predetermined pattern and a spacer layer with a complementary pattern of the predetermined pattern, which electrode layer and spacer layer are laminated on an upper surface of the dielectric layer through the adhesive layer, using (I) an electrode layer-forming roll (1) obtained by winding up an electrode sheet (10) having a layer structure comprising a first substrate sheet (11) and an electrode-spacer layer (14) into a roll shape; (II) an adhesive layer-forming roll (2) obtained by winding up an adhesive layer-forming sheet (20) having a layer structure comprising a back transfer (offset)-preventing layer (21), a second substrate sheet (22) and the adhesive layer (24) into a roll shape; and (III) a green sheet roll (3) obtained by winding up the ceramic green sheet (30) having a layer structure comprising a third substrate sheet (31) and the dielectric layer (33) into a roll shape, the said process comprising:

(A) a first step of transferring only the adhesive layer (24) of the adhesive layer-forming sheet (20) wound off from the adhesive layer-forming roll (2) onto an upper surface of the electrode-spacer layer (14) of the electrode sheet (10), while winding off the electrode sheet (10) from the electrode layer-forming roll (1);

(B) a second step of transferring only the dielectric layer (33) of the ceramic green sheet (30) wound off from the green sheet roll (3) onto the adhesive layer (24) transferred onto the upper surface of the electrode sheet (10) delivered from the first transfer step;

(C) a third step of bonding the adhesive layer-forming sheet (20) wound off from the adhesive layer-forming roll (2) onto the dielectric layer (33) transferred onto the upper surface of the electrode sheet (10) delivered from the second transfer step, through the adhesive layer (24) of the adhesive layer-forming sheet (20), thereby forming a multilayer sheet (40); and

(D) a fourth step of winding up the multilayer sheet (40) delivered from the third step, thereby producing a multilayer sheet roll (4).

In a second aspect of the present invention, there is provided a process for producing a multilayer for a multilayer electronic device, comprising a dielectric layer of a ceramic green sheet, an adhesive layer, an electrode layer with a predetermined pattern and a spacer layer with a complementary pattern of the predetermined pattern, which electrode layer and spacer layer are laminated on an upper surface of the dielectric layer through the adhesive layer, using (I) a green sheet roll (3) obtained by winding up the ceramic green sheet (30) having a layer structure comprising a third substrate sheet (31) and the dielectric layer (33) into a roll shape, (II) an adhesive layer-forming roll (2) obtained by winding up an adhesive layer-forming sheet (20) having a layer structure comprising a back transfer (offset)-preventing layer (21), a second substrate sheet (22) and the adhesive layer (24) into a roll shape and (III) an electrode layer-forming roll (1) obtained by winding up an electrode sheet (10) having a layer structure comprising a first substrate sheet (11) and an electrode-spacer layer (14) into a roll shape, the said process comprising:

(A) a first step of transferring only the adhesive layer (24) of the adhesive layer-forming sheet (20) wound off from the adhesive layer-forming roll (2) onto an upper surface of the dielectric layer (33) of the ceramic green sheet (30), while winding off the ceramic green sheet (30) from the green sheet roll (3);

(B) a second step of transferring only the electrode-spacer layer (14) of the electrode sheet (10) wound off from the electrode layer-forming roll (1) onto the adhesive layer (24) transferred onto an upper surface of the ceramic green sheet (30) delivered from the first transfer step;

(C) a third step of bonding the adhesive layer-forming sheet (20) wound off from the adhesive layer-forming roll (2) onto the electrode-spacer layer (14) transferred onto the upper surface of the ceramic green sheet (30) delivered from the second transfer step, through the adhesive layer (24) of the adhesive layer-forming sheet (20), thereby forming a multilayer sheet (40); and

(D) a fourth step of winding up the multilayer sheet (40) delivered from the third step, thereby producing a multilayer sheet roll (4).

### EFFECT OF THE INVENTION

In accordance with the present invention, there is provided a process for producing a multilayer for a multilayer electronic device including a dielectric layer and an electrode layer which process is improved so as to prevent penetration of an electrode paste into the dielectric layer as well as deformation of the dielectric layer and electrode layer, allow raw material sheets required for producing the respective layers such as an adhesive layer-forming sheet to be used in the form of a roll without problems such as back transfer (offset), and allow a multilayer sheet including an adhesive layer to be produced in the form of a roll without problems such as back transfer (offset).

### BRIEF DESCRIPTION OF THE DRAWINGS

FIG. 1 is a schematic explanatory process diagram showing an example of the production process according to the first aspect of the present invention.

FIG. 2 is an explanatory view of essential parts showing an example of the production process according to the first aspect of the present invention.

FIG. 3 is an explanatory view of essential parts showing an example of the production process according to the first aspect of the present invention.

FIG. 4 is an explanatory view of essential parts showing an example of the production process according to the first aspect of the present invention.

FIG. 5 is a schematic explanatory process diagram showing an example of the production process according to the second aspect of the present invention.

FIG. 6 is an explanatory view of essential parts showing an example of the production process according to the second aspect of the present invention.

FIG. 7 is an explanatory view of essential parts showing an example of the production process according to the second aspect of the present invention.

FIG. 8 is an explanatory view of essential parts showing an example of the production process according to the second aspect of the present invention.

### EXPLANATION OF REFERENCE NUMERALS:

1: Electrode layer-forming roll; 10: electrode sheet; 11: first substrate sheet; 12: release layer; 13: print-assisting layer; 14: electrode-spacer layer; 14a: electrode layer; 14b: spacer layer; 2: adhesive layer-forming roll; 20: adhesive layer-forming sheet; 21: back transfer (offset)-preventing layer; 22: second substrate sheet; 23: release layer; 24: adhesive layer; 3: green sheet roll; 30: ceramic green sheet; 31: third substrate sheet; 32: release layer; 33: dielectric layer; 4: multilayer sheet roll; 40: multilayer sheet; 5 to 7: winding rollers; 7a, 7b: pair of pressure rollers; 8a, 8b: pair of pressure rollers; 9a, 9b: pair of pressure rollers

### PREFERRED EMBODIMENT FOR CARRYING OUT THE INVENTION

The present invention is described in detail below by referring to the accompanying drawings. In the following descriptions, although an electrode sheet is wound up into an electrode layer-forming roll such that an electrode-spacer layer is located outside, an adhesive layer-forming sheet is wound up into an adhesive layer-forming roll such that an adhesive layer is located inside, and a ceramic green sheet is wound up into a green sheet roll such that a dielectric layer is located inside. However, these sheets may be rolled up in a reversed manner.

The present invention relates to the process for producing a multilayer for a multilayer electronic device, which includes a dielectric layer of a ceramic green sheet, an adhesive layer, and an electrode layer with a predetermined pattern and a spacer layer with a complementary pattern of the predetermined pattern which are laminated on an upper surface of the dielectric layer through the adhesive layer. In the process of the present invention, three kinds of rolls are used, and four steps are conducted. The present invention includes two aspects in which the same kinds of rolls are used.

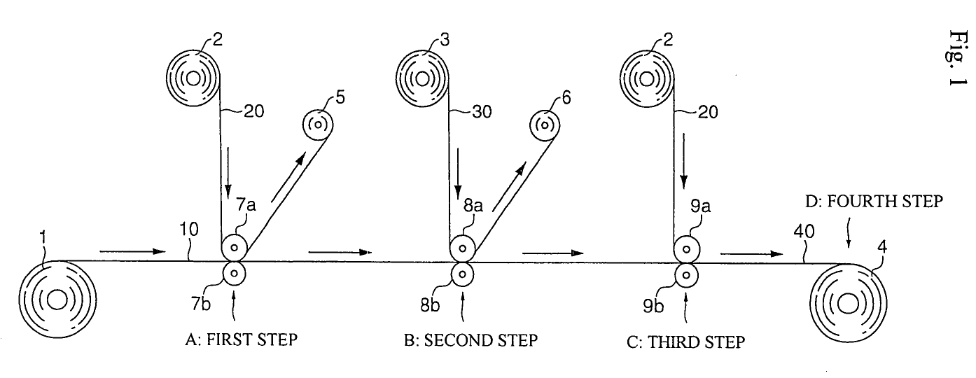

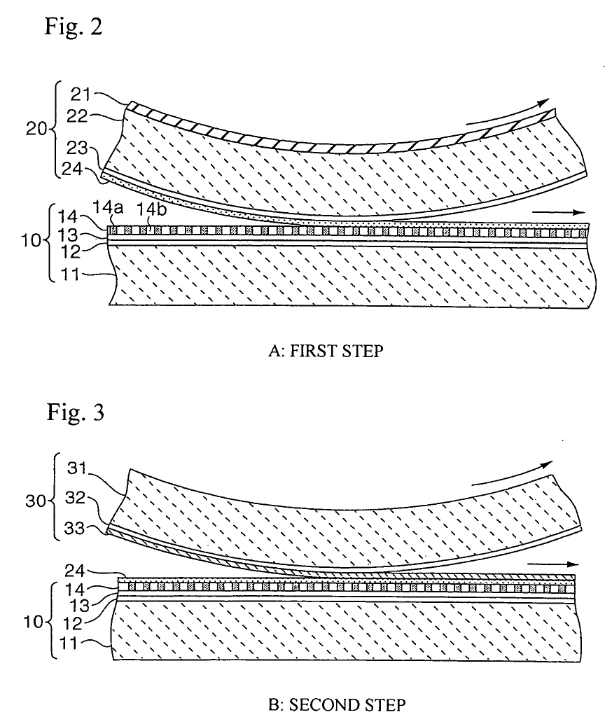

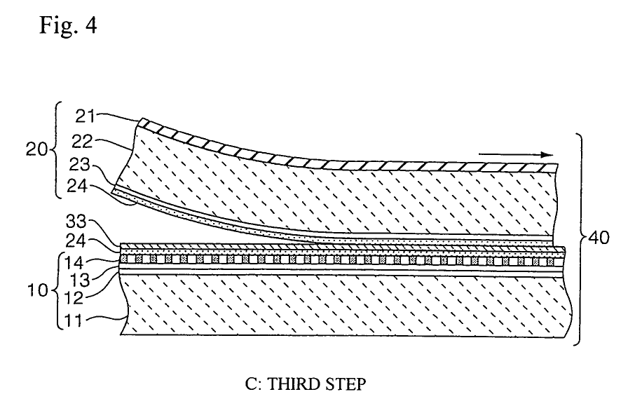

First Aspect of the Present Invention (FIGS. 1 to 4)

First, the three kinds of rolls used in the present invention, i.e., the electrode layer-forming roll (1), the adhesive layer-forming roll (2) and the green sheet roll (3), are explained. For the convenience of explanation, the green sheet roll (3) is first described.

<Green Sheet Roll (3)>

The green sheet roll (3) is constituted from a ceramic green sheet (30) having a layer structure composed of a third substrate sheet (31) and a dielectric layer (33). In the preferred embodiment of the present invention, the ceramic green sheet (30) has a layer structure composed of the third substrate sheet (31), a release layer (32) and the dielectric layer (33).

The above ceramic green sheet (30) is obtained by applying a release agent onto an upper surface of the third substrate sheet (31) and drying the resultant coating layer to form the release layer (32), and then applying a dielectric paste onto an upper surface of the release layer (32) and drying the resultant coating layer to form the dielectric layer (33).

Examples of materials of the third substrate sheet (31) may include polyethylene terephthalate (PET), polypropylene terephthalate (PP), etc. The third substrate sheet (31) has a thickness of usually 5 to 100 μm. Such materials and thickness of the third substrate sheet are identical to those of the other substrate sheets.

A release agent coating solution may be prepared by mixing the release agent and an organic solvent with each other. Examples of the release agent usable in the present invention may include alkyd resins, silicone resins, etc.

Among these release agents, preferred are silicone resins. Examples of the organic solvent may include toluene, methyl ethyl ketone, acetone, etc. The content of the release agent in the release agent coating solution is usually 0.01 to 5% by weight.

The release agent coating solution is applied, for example, using a bar coater, an extrusion coater, a reverse coater, a dip coater, a kiss-roll coater, etc. The drying of the applied release agent coating solution is conducted at a temperature of from room temperature (25° C.) to 150° C. for about 1 to 5 min. The release layer (32) obtained after the drying is usually 0.02 to 0.3 μm, preferably 0.02 to 0.1 μm. The peel strength of the release layer (32) is usually 2 to 30 mN/cm.

The dielectric paste may be usually prepared by kneading a raw dielectric material with an organic vehicle obtained by dissolving a binder in an organic solvent.

As the raw dielectric material, there may be usually used composite oxide particles having an average particle diameter of 0.1 to 3.0 μm such as composite oxide particles of calcium titanate, strontium titanate or barium titanate. The particle diameter of the raw dielectric material is preferably smaller than the thickness of the ceramic green sheet (30).

Examples of the binder used in the organic vehicle may include ethyl cellulose, polyvinyl butyral, acrylic resins, etc. Among these binders, preferred are butyral-based resins such as polyvinyl butyral in order to obtain the ceramic green sheet of a thin film shape. Examples of the organic solvent used in the organic vehicle may include terpineol, butyl carbitol, acetone, toluene, etc.

In the present invention, the dielectric paste may also be prepared by kneading the raw dielectric material with a vehicle obtained by dissolving a water-soluble binder in water. As the water-soluble binder, there may be used polyvinyl alcohol, methyl cellulose, hydroxyethyl cellulose, water-soluble acrylic resins, emulsions, etc.

The dielectric paste may also contain, if required, additives selected from various dispersants, plasticizers, dielectric materials, compounds as auxiliary components, glass frit and insulating materials.

The contents of the above respective components in the dielectric paste are as follows. That is, the content of the raw dielectric material in the dielectric paste is usually 20 to 60% by weight, the content of the binder is usually 2 to 10% by weight, the content of the organic solvent is usually 50 to 70% by weight, and the content of the above additives is usually 1 to 10% by weight.

When the butyral-based resin is used as the binder resin, the content of the plasticizer is preferably selected from the range of 25 to 100 parts by weight based on 100 parts by weight of the binder resin. When the content of the plasticizer is too small, the obtained dielectric layer (33) tends to become brittle. When the content of the plasticizer is too large, the plasticizer tends to be eluted out of the obtained dielectric layer, resulting in poor handling property thereof. Examples of the plasticizer may include phthalic esters, glycols, adipic acid, phosphoric esters, etc. Examples of the organic solvent may include toluene, methyl ethyl ketone, acetone, etc.

The coating of the dielectric paste may be conducted using an extrusion coater, a wire bar coater, etc. The drying of the applied dielectric paste may be conducted at a temperature of about 50 to 100° C. for about 1 to 20 min. The thickness of the dielectric layer (33) obtained after the drying is usually 0.02 to 3 μm and preferably 0.02 to 1.5 μm.

The thus obtained ceramic green sheet (30) is wound up such that the dielectric layer (33) is located outside, and used as the green sheet roll (3).

<Adhesive Layer-Forming Roll (2)>

The adhesive layer-forming roll (2) is constituted from the adhesive layer-forming sheet (20) having a layer structure including a back transfer (offset)-preventing layer (21), a second substrate sheet (22) and an adhesive layer (24). In the preferred embodiment of the present invention, the adhesive layer-forming sheet (20) has a layer structure including the back transfer (offset)-preventing layer (21), the second substrate sheet (22), a release layer (23) and the adhesive layer (24).

The above adhesive layer-forming sheet (20) is obtained by applying a release agent coating solution onto one side upper surface of the second substrate sheet (22) and drying the obtained coating layer to form the back transfer (offset)-preventing layer (21); applying the release agent coating solution onto the other side upper surface of the second substrate sheet (22) and drying the obtained coating layer to form the release layer (23); and then applying an adhesive coating solution onto an upper surface of the release layer (23) and drying the obtained coating layer to form the adhesive layer (24).

Both the release agent coating solutions used for forming the back transfer (offset)-preventing layer (21) and the release layer (23) may be the same as that used for forming the ceramic green sheet (30). In the preferred embodiment of the present invention, the second substrate sheet (22) is provided on both surfaces thereof with silicone resin layers which are used as the back transfer (offset)-layer (21) and the release layer (23), respectively.

The adhesive coating solution is prepared from a binder and an organic solvent, and may further contain as optional components, dielectric particles having the same composition as that of dielectric particles contained in the ceramic green sheet (30), a plasticizer, a release agent and an antistatic agent. In particular, the adhesive layer (24) containing the antistatic agent is preferable, because the second substrate sheet (22) is easily peeled and separated from the adhesive layer (24).

The binder, organic solvent, plasticizer and release agent used in the adhesive coating solution may be the same as those used for the ceramic green sheet (30). Examples of the antistatic agent may include ethyleneglycol, polyethyleneglycol, 2,3-butanediol, glycerol, amphoteric surfactants such as imidazoline-based surfactants, polyalkyleneglycol derivative-based surfactants and carboxylic acid amidine salt-based surfactants, etc. Among these antistatic agents, preferred are the amphoteric surfactants, and more preferred are the imidazoline-based surfactants.

The contents of the above respective components in the adhesive coating solution are as follows. That is, the content of the binder in the adhesive coating solution is usually 1 to 10% by weight; the content of the organic solvent is usually 90 to 99% by weight; the content of the dielectric particles is usually 90 to 99% by weight; the content of the release agent is usually 0.1 to 20% by weight; the content of the antistatic agent is usually 0.01 to 5% by weight; and the content of the plasticizer is usually 10 to 100% by weight based on the binder.

The coating and drying of the release agent coating solution and the adhesive coating solution may be conducted by the same method as used for forming the ceramic green sheet (30). The thicknesses of the release agent layers (back transfer (offset)-preventing layer (21) and release layer (23)) and the adhesive layer (24) are respectively usually 0.02 to 0.3 μm, preferably 0.02 to 0.1 μm. When the thickness of the adhesive layer (24) is less than 0.02 μm, the obtained adhesive layer tends to be lowered in adhesion strength. When the thickness of the adhesive layer is more than 0.3 μm, the adhesive layer tends to suffer from defects (voids). The peel strength of the release layer (23) is usually 2 to 30 mN/cm.

The thus obtained adhesive layer-forming sheet (20) is wound up such that the adhesive layer (24) is located inside, and used as the adhesive layer-forming roll (2).

<Electrode Layer-Forming Roll (1)>

The electrode layer-forming roll (1) is constituted from an electrode sheet (10) having a layer structure including a first substrate sheet (11) and an electrode-spacer layer (14). In the preferred embodiment of the present invention, the electrode sheet (10) has a layer structure including the first substrate sheet (11), a release layer (12) and the electrode-spacer layer (14). In the more preferred embodiment of the present invention, the electrode sheet (10) has a layer structure including the first substrate sheet (11), the release layer (12), a print-assisting layer (13) and the electrode-spacer layer (14). The print-assisting layer (13) serves for facilitating formation of the electrode-spacer layer (14).

The above electrode sheet (10) may be obtained by applying a release agent coating solution onto one side upper surface of the first substrate sheet (11) and drying the obtained coating layer to form the release layer (12); applying a dielectric paste onto an upper surface of the release layer (12) and drying the obtained coating layer to form the print-assisting layer (13); and then applying an electrode paste and a dielectric paste (spacer layer-forming paste) in an optional different order and drying the obtained coating layer to form the electrode-spacer layer (14).

The release agent coating solution may be the same as that used for forming the ceramic green sheet (30). As the preferred release agent, there may be used silicone reins. The dielectric paste may be prepared by the same method as used for forming the ceramic green sheet (30).

The electrode paste may be usually prepared by kneading a conductive material composed of various conductive metals or alloys with an organic vehicle obtained by dissolving a binder in an organic solvent, and may further contain a plasticizer as an optional component. The plasticizer exhibits the effect of improving an adhesion property of the electrode paste.

As the conductive material, there may be suitably used Ni and/or Ni alloys. The average particle diameter of the conductive material is usually 0.1 to 2 μm, preferably 0.2 to 1 μm. Examples of the binder may include ethyl cellulose, acrylic resins, polyvinyl butyral, polyvinyl acetal, polyvinyl alcohol, polyolefins, polyurethanes, polystyrenes and copolymers of these compounds. Among these binders, preferred are butyral-based binders such as polyvinyl butyral. Examples of the solvent may include terpineol, butyl carbitol, kerosene, etc. Examples of the plasticizer may include phthalic esters such as benzylbutyl phthalate (BBP), adipic acid, phosphoric esters, glycols, etc.

The contents of the respective components in the electrode paste are as follows. That is, the content of the conductive material in the electrode paste is usually 40 to 50% by weight; the content of the organic solvent is usually 20 to 60% by weight; the content of the binder is usually 1 to 40% by weight; and the content of the plasticizer is usually 0.2 to 10% by weight based on the binder.

The coating and drying of the release agent coating solution may be conducted by the same methods as used for forming the ceramic green sheet (30). The thickness of the release layer (12) obtained after the drying is usually 0.02 to 0.3 μm, preferably 0.02 to 0.1 μm. The printing and drying of the electrode paste may be conducted by the same method as used for forming the ceramic green sheet (30). The print-assisting layer (13) obtained after the drying is usually 0.01 to 1 μm, preferably 0.05 to 0.5 μm. The peel strength of the release layer (12) is usually 2 to 30 mN/cm.

The printing of the electrode paste and the dielectric paste may be conducted using a printing machine such as a screen printing machine and a gravure printing machine. The drying of the printed layer may be conducted at a temperature of about 50 to 100° C. for about 1 to 20 min. The thickness of the electrode-spacer layer (14) is usually 0.1 to 5 μm, preferably 0.1 to 1.5 μm. Either the electrode layer (14a) or the spacer layer (14b) may be formed first.

For example, after forming the electrode layer (14a) with a predetermined pattern onto the print-assisting layer (13) formed on an upper surface of the first substrate sheet (11), a complementary pattern of the dielectric paste is further printed on a portion where no electrode layer (14a) is formed, using a printing machine, thereby forming the spacer layer (14b).

The thus obtained electrode sheet (10) is wound up such that the electrode-spacer layer (14) is located inside, and used as the electrode layer-forming roll.

(A: First Step)

In the first step, while winding off the electrode sheet (10) from the electrode layer-forming roll (1), only the adhesive layer (24) of the adhesive layer-forming sheet (20) wound off from the adhesive layer-forming roll (2) is transferred onto an upper surface of the electrode-spacer layer (14) of the electrode sheet (10).

In the above transfer treatment, the electrode sheet (10) and the adhesive layer-forming sheet (20) are disposed such that the electrode-spacer layer (14) and the adhesive layer (24) are overlapped on each other, and then passed between a pair of pressure rollers (7a) and (7b). The transfer temperature (temperature of the pressure rollers) is usually 40 to 100° C., and the transfer pressure is usually 0.2 to 15 MPa, preferably 0.2 to 6 MPa. With this transfer treatment, the adhesive layer-forming sheet (20) undergoes separation of the adhesive layer (24) therefrom, so that only the adhesive layer (24) is transferred onto an upper surface of the electrode-spacer layer (14). The adhesive layer-forming sheet from which the adhesive layer (24) is separated is wound up and recovered by a winding roller (5).

In the above transfer treatment, the winding-off of the adhesive layer-forming sheet (20) from the adhesive layer-forming roll (2) can be smoothly performed while preventing back transfer (offset) of the adhesive layer (24) due to the effect of the back transfer (offset)-preventing layer (21). In addition, the transfer of only the adhesive layer (24) onto the electrode-spacer layer (14) can be further ensured by the release layer (23) provided between the second substrate sheet (22) and the adhesive layer (24) of the adhesive layer-forming roll (20).

(B: Second Step)

In the second step, only the dielectric layer (33) of the ceramic green sheet (30) wound off from the green sheet roll (3) is transferred onto the adhesive layer (24) laminated on an upper surface of the electrode sheet (10) delivered from the first transfer step.

In the above transfer treatment, the electrode sheet (10) delivered from the first step and the ceramic green sheet (30) are disposed such that the adhesive layer (24) laminated on the electrode sheet (10) and the dielectric layer (33) of the ceramic green sheet (30) are overlapped with each other, and then passed between a pair of pressure rollers (8a) and (8b). The transfer conditions used in the second step are the same as those used in the first step. With this transfer treatment, the ceramic green sheet (30) undergoes separation of the dielectric layer (33) therefrom, so that only the dielectric layer (33) is transferred onto an upper surface of the adhesive layer (24). The ceramic green sheet from which the dielectric layer (33) is separated is wound up and recovered by a winding roller (6).

In the above transfer treatment, the transfer of only the dielectric layer (33) onto the adhesive layer (24) can be further ensured by the release layer (32) provided between the third substrate sheet (31) and the dielectric layer (33) of the ceramic green sheet (30).

(C: Third step)

In the third step, the adhesive layer-forming sheet (20) wound off from the adhesive layer-forming roll (2) is bonded onto the dielectric layer (33) laminated on an upper surface of the electrode sheet (10) delivered from the second transfer step, through the adhesive layer (24) of the adhesive layer-forming sheet (20), thereby forming a multilayer sheet (40).

In the above adhesion treatment, the electrode sheet (10) and the adhesive layer-forming sheet (20) are disposed such that the dielectric layer (33) and the adhesive layer (24) are overlapped with each other, and then passed between a pair of pressure rollers (9a) and (9b). The adhesion treatment conditions used in the third step are the same as those used in the first step. With this adhesion treatment, there is formed the multilayer sheet (40) having a layer structure composed of the first substrate sheet (11)/the release layer (12)/the print-assisting layer (13)/the electrode-spacer layer (14)/the adhesive layer (24)/the dielectric layer (33)/[the adhesive layer (24)/the release layer (23)/the second substrate sheet (22)/the back transfer (offset)-preventing layer (21)].

(D: Fourth Step)

In the fourth step, the multilayer sheet (40) delivered from the third step is wound up to form the multilayer sheet roll (4). In the multilayer sheet roll (4), since the back transfer (offset)-preventing layer (21) is intervened between respective layer-like overlapped portions of the laminated unit sheet (40) rolled up, back transfer (offset) between the overlapped portions can be surely prevented.

The thus obtained multilayer sheet roll (4) may be used for production of laminated ceramic electronic parts such as multilayer ceramic capacitors in the following manner. That is, the multilayer sheet (40) is drawn off from the multilayer sheet roll (4), and cut into a desired size. After separating a portion of the resultant multilayer having a layer structure composed of the electrode-spacer layer (14)/the adhesive layer (24)/the dielectric layer (33)/the adhesive layer (24) from the remaining portion thereof, a desired number of the multilayers are overlapped and laminated with each other through the respective adhesive layers (24). In this case, the lamination of the multilayers can be extremely easily performed using the adhesive layers (24) contained in the respective multilayers. Thereafter, the multilayers thus overlapped are compressed together, and the resultant laminate is cut into a chip shape to produce green chips. Finally, the thus obtained green chips are successively subjected to removal of the binder therefrom, baking and formation of external electrodes thereon, thereby producing laminated ceramic electronic parts such as multilayer ceramic capacitors.

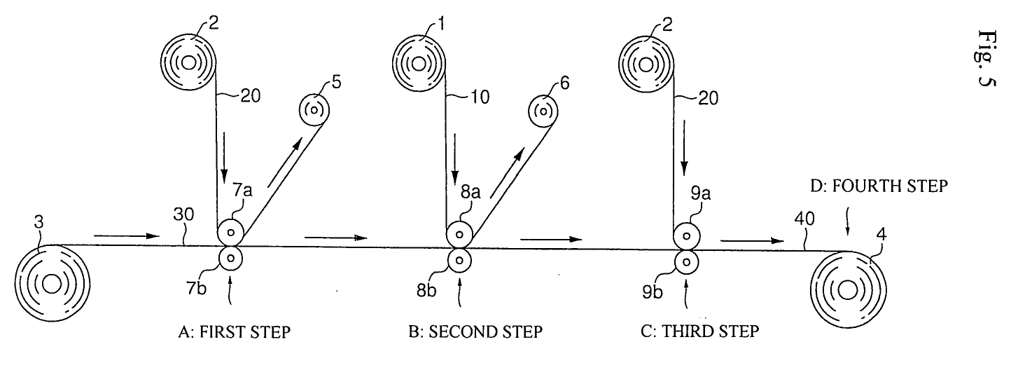

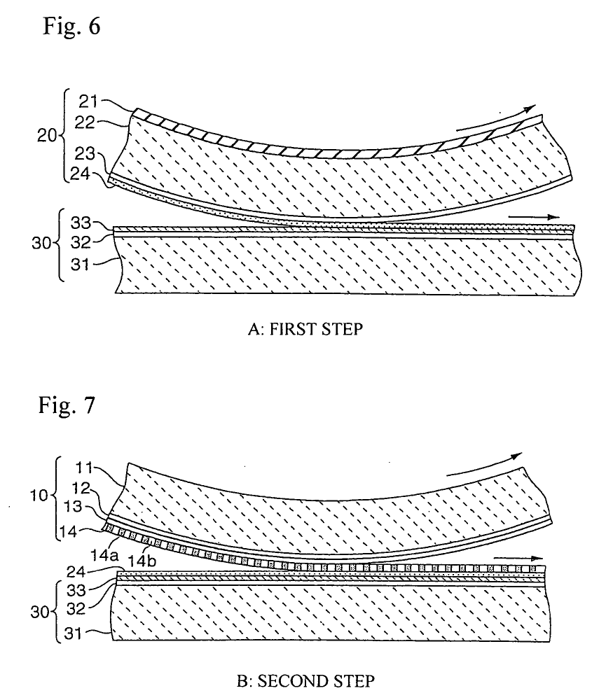

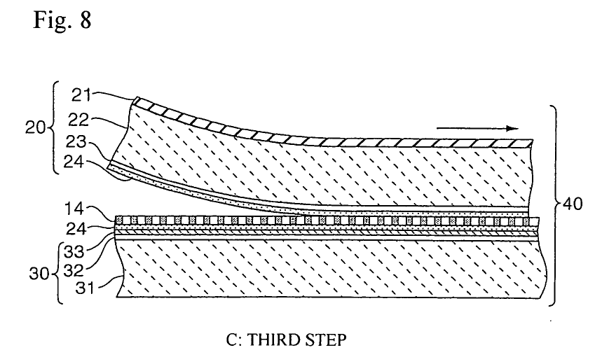

Second Aspect of the Present Invention (FIGS. 5 to 8)

The second aspect of the present invention is substantially the same as the first aspect of the present invention except that the electrode layer-forming roll (1) and the green sheet roll (3) used in the first and second steps, respectively, in the process of the first aspect of the present invention is exchanged with each other, i.e., the green sheet roll (3) is used in the first step.

(A: First Step)

In the first step of the process according to the second aspect of the present invention, while winding off the ceramic green sheet (30) from the green sheet roll (3), only the adhesive layer (24) of the adhesive layer-forming sheet (20) wound off from the adhesive layer-forming roll (2) is transferred onto an upper surface of the dielectric layer (33) of the ceramic green sheet (30).

In the above transfer treatment, the ceramic green sheet (30) and the adhesive layer-forming sheet (20) are disposed such that the dielectric layer (33) and the adhesive layer (24) are overlapped with each other, and then passed between a pair of pressure rollers (7a) and (7b). The transfer conditions of the first step according to the second aspect of the present invention are the same as those of the first step according to the first aspect of the present invention. With the transfer treatment, the adhesive layer-forming sheet (20) undergoes separation of the adhesive layer (24) therefrom, so that only the adhesive layer (24) is transferred onto an upper surface of the dielectric layer (33). The adhesive layer-forming sheet from which the adhesive layer (24) is separated is wound up and recovered by a winding roller (5).

(B: Second Step)

In the second step according to the second aspect of the present invention, only the electrode-spacer layer (14) of the electrode sheet (10) wound off from the electrode layer-forming roll (1) is transferred onto the adhesive layer (24) laminated on an upper surface of the ceramic green sheet (30) delivered from the first transfer step.

In the above transfer treatment, the ceramic green sheet (30) and the electrode sheet (10) are disposed such that the adhesive layers (24) of the ceramic green sheet (30) and the electrode-spacer layer (14) of the electrode sheet (10) are overlapped with each other, and then passed between a pair of pressure rollers (8a) and (8b). The transfer conditions used in the second step according to the second aspect of the present invention are the same as those used in the second step according to the first aspect of the present invention. With this transfer treatment, the electrode sheet (10) undergoes separation of the electrode-spacer layer (14) therefrom, so that only the electrode-spacer layer (14) is transferred onto an upper surface of the adhesive layer (24). The electrode sheet from which the electrode-spacer layer (14) is separated is wound up and recovered by a winding roller (6).

(C: Third step)

In the third step according to the second aspect of the present invention, the adhesive layer-forming sheet (20) wound off from the adhesive layer-forming roll (2) is bonded onto the electrode-spacer layer (14) transferred onto an upper surface of the ceramic green sheet (30) delivered from the second transfer step, through the adhesive layer (24) of the adhesive layer-forming sheet (20), thereby forming a multilayer sheet (40).

In the above adhesion treatment, the ceramic green sheet (30) and the adhesive layer-forming sheet (20) are disposed such that the electrode-spacer layer (14) and the adhesive layer (24) are overlapped with each other, and then passed between a pair of pressure rollers (9a) and (9b). The adhesion treatment conditions used in this third step according to the second aspect of the present invention are the same as those used in the third step according to the first aspect of the present invention. With this adhesion treatment, there is formed the multilayer sheet (40) having a layer structure composed of the third substrate sheet (31)/the release layer (32)/the dielectric layer (33)/the adhesive layer (24)/the electrode-spacer layer (14)/[the adhesive layer (24)/the release layer (23)/the second substrate sheet (22)/the back transfer (offset)-preventing layer (21)].

(D: Fourth Step)

In the fourth step according to the second aspect of the present invention, the multilayer sheet (40) delivered from the third step is wound up to form the multilayer sheet roll (4). In the multilayer sheet roll (4), since the back transfer (offset)-preventing layer (21) is intervened between respective layer-like overlapped portions of the laminated unit sheet (40) rolled up, back transfer (offset) between the overlapped portions can be surely prevented.

The thus obtained multilayer sheet roll (4) is used for production of laminated ceramic electronic parts such as multilayer ceramic capacitors in the same manner as described in the first aspect of the present invention. In this case, the lamination of the multilayers can also be extremely easily performed using the adhesive layers (24) contained in the respective multilayers.

### EXAMPLES

The present invention is described in more detail by Examples, but the Examples are only illustrative and not intended to limit the scope of the present invention.

(1) Substrate Sheet:

As the first substrate sheet (11) for forming the electrode sheet (10) and the third substrate sheet (31) for forming the ceramic green sheet (30), there was used a commercially available a biaxially stretched polyethylene terephthalate film (thickness: 38 μm) provided on one surface thereof with a release layer (thickness: 0.1 μm) made of a silicone resin. Also, as the second substrate sheet (21) for forming the adhesive layer-forming sheet (20), there was used a commercially available a biaxially stretched polyethylene terephthalate film (thickness: 38 μm) provided on both surfaces thereof with a release layer (thickness: 0.1 μm) made of a silicone resin.

(2) Production of Dielectric Paste (A):

Dielectric particles having a composition shown in Table 1 were prepared. 100 parts by weight of the thus prepared dielectric particles were mixed with an organic vehicle having a composition shown in Table 2 below using a ball mill for 20 hours, and the resultant mixture was diluted with a mixed solution containing ethanol, propanol and xylene at a weight ratio of 42.5:42.5:15, thereby preparing a dielectric paste (A).

TABLE 1

| Components | Content (weight part) |
|---|---|
| BaTiO₃ particles (tradename: | 100.00 |
| “BT-01” produced by Sakai | |
| Kagaku Kogyo Co., Ltd.) | |
| MgCO₃ | 0.72 |
| MnO | 0.13 |
| (Ba_{0.6}Ca_{0.4})SiO₃ | 1.50 |
| Y₂O₃ | 1.00 |

TABLE 2

| Components | Content (weight part) |
|---|---|
| Polyvinyl butyral resin | 6.0 |
| (binder) | |
| Bis(2-ethylhexyl)phthalate | 3.0 |
| (DOP: plasticizer) | |
| Ethanol | 78.0 |
| n-Propanol | 78.0 |
| Xylene | 14.0 |
| Mineral spirit | 7.0 |
| Dispersant | 0.7 |

(3) Production of Dielectric Paste (B):

100 parts by weight of the dielectric particles used for production of the dielectric paste (A) were mixed with a solution having a composition shown in Table 3 below using a ball mill for 20 hours to obtain a slurry. Thereafter, the thus obtained slurry was heated at 40° C. under stirring to volatilize an excess of acetone, thereby preparing a dielectric paste (B) for forming a spacer layer.

TABLE 3

| Components | Content (weight part) |
|---|---|
| Organic vehicle (prepared by | 71 |
| dissolving 8 parts by weight | |
| of polyvinyl butyral in 92 | |
| parts by weight of terpineol) | |
| Bis(2-ethylhexyl)phthalate | 50 |
| (DOP: plasticizer) | |
| Terpineol | 5 |
| Dispersant | 1 |
| Acetone | 64 |

(4) Production of Adhesive Coating Solution:

An organic vehicle having a composition shown in Table 4 below was prepared, and diluted 10 times with methyl ethyl ketone, thereby preparing an adhesive coating solution.

TABLE 4

| Components | Content (weight part) |
|---|---|
| Polyvinyl butyral resin | 100 |
| (binder) | |
| Bis(2-ethylhexyl)phthalate | 50 |
| (DOP: plasticizer) | |
| Methyl ethyl ketone | 900 |
| Imidazoline-based surfactant | 5 |

100 parts by weight of Ni particles having an average particle size of 0.2 μm were mixed with a solution having a composition shown in Table 5 below using a ball mill for 20 hours to obtain a slurry. Thereafter, the resultant slurry was heated at 40° C. under stirring to volatilize an excess of acetone, thereby preparing a paste for forming an electrode layer.

TABLE 5

| Components | Content (weight part) |
|---|---|
| BaTiO₃ particles (tradename: | 20 |
| “BT-01” produced by Sakai | |
| Kagaku Kogyo Co., Ltd.) | |
| Organic vehicle (prepared by | 58 |
| dissolving 8 parts by weight | |
| of polyvinyl butyral in 92 | |
| parts by weight of terpineol) | |
| Bis(2-ethylhexyl)phthalate | 50 |
| (DOP: plasticizer) | |
| Terpineol | 5 |
| Dispersant | 1 |
| Acetone | 45 |

<Production of Green Sheet Roll (3)>

The dielectric paste (A) was coated onto an upper surface of the release layer (32) formed on the third substrate sheet (31), and then dried to form the dielectric layer (33). The coating of the dielectric paste was performed using an extrusion coater, and the drying thereof was performed at a temperature of about 80° C. for about 10 min using a box-type dryer. The dried dielectric layer (33) had a thickness of 0.9 μm. The thus obtained ceramic green sheet (30) was wound up such that the dielectric layer (33) was located outside, thereby obtaining the green sheet roll (3).

<Production of Adhesive Layer-Forming Roll (2)>

The release layer (silicone resin layer) formed on one side upper surface of the second substrate sheet (22) was used as the back transfer (offset)-preventing layer (21). The adhesive coating solution was coated onto an upper surface of the release layer (silicone resin layer) formed on the other side upper surface of the second substrate sheet, and then dried to form the adhesive layer (24). The coating of the adhesive coating solution was performed using a wire bar coater, and the drying thereof was performed at a temperature of about 80° C. for about 10 min using a box-type dryer. The dried adhesive layer (24) had a thickness of 0.1 μm. The thus obtained adhesive layer-forming sheet (20) was wound up such that the adhesive layer (24) was located inside, thereby obtaining the adhesive layer-forming roll (2).

<Production of Electrode Layer-Forming Roll (1)>

The dielectric paste (A) was coated onto an upper surface of the release layer (12) formed on the first substrate sheet (11), and then dried to form the print-assisting layer (13). Next, the electrode paste was applied onto an upper surface of the print-assisting layer (13) so as to form a predetermined pattern of the electrode paste thereon, and then dried to form the electrode layer (14a). Further, the dielectric paste (B) was applied onto the upper surface of the print-assisting layer (13) to form a pattern of the dielectric paste (B) which had a complementary relation to the predetermined pattern of the electrode layer (14a) thereon, and then dried to form the spacer layer (14b).

The coating of the dielectric paste (A) was performed using an extrusion coater, and the drying thereof was performed at a temperature of about 80° C. for about 10 min using a box-type dryer. The dried print-assisting layer (13) had a thickness of 0.2 μm. Also, the printing of the electrode paste and the dielectric paste was performed using a screen printing machine, and the drying thereof was performed at a temperature of about 85° C. for about 15 min using a box-type dryer. The dried electrode-spacer layer (14) had a thickness of 1.2 μm. The thus obtained electrode sheet (10) was wound up such that the electrode-spacer layer (14) was located inside, thereby obtaining the electrode layer-forming roll (1).

(A: First Step)

While winding off the electrode sheet (10) from the electrode layer-forming roll (1), the adhesive layer (24) of the adhesive layer-forming sheet (20) wound off from the adhesive layer-forming roll (2) is transferred onto an upper surface of the electrode-spacer layer (14) of the electrode sheet (10). More specifically, the electrode sheet (10) and the adhesive layer-forming sheet (20) were disposed such that the electrode-spacer layer (14) and the adhesive layer (24) were overlapped with each other, and then passed between a pair of pressure rollers (7a) and (7b). The transfer temperature (temperature of the pressure rollers) was adjusted to 70° C., and the transfer pressure was adjusted to 1 MPa. With this transfer treatment, the adhesive layer-forming sheet (20) underwent separation of the adhesive layer (24) therefrom, so that only the adhesive layer (24) was transferred onto an upper surface of the electrode-spacer layer (14). The adhesive layer-forming sheet from which the adhesive layer (24) was separated was wound up and recovered by a winding roller (5).

(B: Second Step)

The dielectric layer (33) of the ceramic green sheet (30) wound off from the green sheet roll (3) is transferred onto the adhesive layer (24) transferred onto an upper surface of the electrode sheet (10) delivered from the first transfer step. More specifically, the electrode sheet (10) and the ceramic green sheet (30) were disposed such that the adhesive layer (24) and the dielectric layer (33) were overlapped with each other, and then passed between a pair of pressure rollers (8a) and (8b). The transfer conditions used in the second step were the same as those used in the first step. With this transfer treatment, the ceramic green sheet (30) underwent separation of the dielectric layer (33) therefrom, so that only the dielectric layer (33) was transferred onto an upper surface of the adhesive layer (24). The ceramic green sheet from which the dielectric layer (33) was separated was wound up and recovered by a winding roller (6).

(C: Third step)

The adhesive layer-forming sheet (20) wound off from the adhesive layer-forming roll (2) was bonded onto the dielectric layer (33) transferred onto an upper surface of the electrode sheet (10) delivered from the second transfer step, through the adhesive layer (24) of the adhesive layer-forming sheet (20), thereby forming the multilayer sheet (40). More specifically, the electrode sheet (10) and the adhesive layer-forming sheet (20) were disposed such that the dielectric layer (33) and the adhesive layer (24) were overlapped with each other, and then passed between a pair of pressure rollers (9a) and (9b). The adhesion treatment conditions used in the third step were the same as those used in the first step.

(D: Fourth Step)

The multilayer sheet (40) delivered from the third step was wound up, thereby obtaining the multilayer sheet roll (4).

<Production of Laminated Ceramic Electronic Parts>

The multilayer sheet (40) was wound off from the multilayer sheet roll (4), and cut into a desired size. After separating a portion of the resultant multilayer having a layer structure composed of the electrode-spacer layer (14)/the adhesive layer (24)/the dielectric layer (33)/the adhesive layer (24) from the remaining portion thereof, a desired number of the multilayers were overlapped and laminated with each other through the respective adhesive layers (24). Thereafter, the multilayers thus overlapped are compressed together, and the resultant laminate was cut into chip-like pieces to produce green chips. Finally, the thus obtained green chips were successively subjected to removal of the binder therefrom, baking and formation of external electrodes thereon to produce a multilayer ceramic capacitor.

In the above first step for producing the multilayer roll (4), the winding-off of the adhesive layer-forming sheet (20) from the adhesive layer-forming roll (2) was smoothly performed, since back transfer (offset) of the adhesive layer (24) was effectively prevented by the effect of the back transfer (offset)-preventing layer (21). Also, in the obtained multilayer sheet roll (4), since the back transfer (offset)-preventing layer (21) was intervened between respective layer-like overlapped portions of the laminated unit sheet (40) rolled up, back transfer (offset) between the overlapped portions could be surely prevented.

Further, upon production of the above laminated ceramic electronic parts, the lamination of the multilayers could be extremely easily performed using the adhesive layers (24) contained in the respective multilayers. As a result of examining the thus obtained multilayer ceramic capacitor, neither penetration of the electrode paste into the dielectric layer nor deformation of the dielectric layer and the electrode layer was recognized.

1. A process for producing a multilayer for a multilayer electronic device, comprising a dielectric layer of a ceramic green sheet, an adhesive layer, an electrode layer with a predetermined pattern and a spacer layer with a complementary pattern of the predetermined pattern, which electrode layer and spacer layer are laminated on an upper surface of the dielectric layer through the adhesive layer, using (I) an electrode layer-forming roll (1) obtained by winding up an electrode sheet (10) having a layer structure comprising a first substrate sheet (11) and an electrode-spacer layer (14) into a roll shape; (II) an adhesive layer-forming roll (2) obtained by winding up an adhesive layer-forming sheet (20) having a layer structure comprising a back transfer (offset)-preventing layer (21), a second substrate sheet (22) and the adhesive layer (24) into a roll shape; and (III) a green sheet roll (3) obtained by winding up the ceramic green sheet (30) having a layer structure comprising a third substrate sheet (31) and the dielectric layer (33) into a roll shape, said process comprising:
(A) a first step of transferring only the adhesive layer (24) of the adhesive layer-forming sheet (20) wound off from the adhesive layer-forming roll (2) onto an upper surface of the electrode-spacer layer (14) of the electrode sheet (10), while winding off the electrode sheet (10) from the electrode layer-forming roll (1);
(B) a second step of transferring only the dielectric layer (33) of the ceramic green sheet (30) wound off from the green sheet roll (3) onto the adhesive layer (24) transferred onto the upper surface of the electrode sheet (10) delivered from the first transfer step;
(C) a third step of bonding the adhesive layer-forming sheet (20) wound off from the adhesive layer-forming roll (2) onto the dielectric layer (33) transferred onto the upper surface of the electrode sheet (10) delivered from the second transfer step, through the adhesive layer (24) of the adhesive layer-forming sheet (20), thereby forming a multilayer sheet (40); and
(D) a fourth step of winding up the multilayer sheet (40) delivered from the third step, thereby producing a multilayer sheet roll (4).

2. A process for producing a multilayer for a multilayer electronic device, comprising a dielectric layer of a ceramic green sheet, an adhesive layer, an electrode layer with a predetermined pattern and a spacer layer with a complementary pattern of the predetermined pattern, which electrode layer and spacer layer are laminated on an upper surface of the dielectric layer through the adhesive layer, using (I) a green sheet roll (3) obtained by winding up the ceramic green sheet (30) having a layer structure comprising a third substrate sheet (31) and the dielectric layer (33) into a roll shape; (II) an adhesive layer-forming roll (2) obtained by winding up an adhesive layer-forming sheet (20) having a layer structure comprising a back transfer (offset)-preventing layer (21), a second substrate sheet (22) and the adhesive layer (24) into a roll shape; and (III) an electrode layer-forming roll (1) obtained by winding up an electrode sheet (10) having a layer structure comprising a first substrate sheet (11) and an electrode-spacer layer (14) into a roll shape, said process comprising:
(A) a first step of transferring only the adhesive layer (24) of the adhesive layer-forming sheet (20) wound off from the adhesive layer-forming roll (2) onto an upper surface of the dielectric layer (33) of the ceramic green sheet (30), while winding off the ceramic green sheet (30) from the green sheet roll (3);
(B) a second step of transferring only the electrode-spacer layer (14) of the electrode sheet (10) wound off from the electrode layer-forming roll (1) onto the adhesive layer (24) transferred onto an upper surface of the ceramic green sheet (30) delivered from the first transfer step;
(C) a third step of bonding the adhesive layer-forming sheet (20) wound off from the adhesive layer-forming roll (2) onto the electrode-spacer layer (14) transferred onto the upper surface of the ceramic green sheet (30) delivered from the second transfer step, through the adhesive layer (24) of the adhesive layer-forming sheet (20), thereby forming a multilayer sheet (40); and
(D) a fourth step of winding up the multilayer sheet (40) delivered from the third step, thereby producing a multilayer sheet roll (4).

3. A process according to claim 1, wherein the electrode sheet (10) has a layer structure comprising the first substrate sheet (11), a release layer (12) and the electrode-spacer layer (14).

4. A process according to claim 1, wherein the electrode sheet (10) has a layer structure comprising the first substrate sheet (11), the release layer (12), a print-assisting layer (13) and the electrode-spacer layer (14).

5. A process according to claim 1 wherein the adhesive layer-forming sheet (20) has a layer structure comprising the back transfer (offset)-preventing layer (21), the second substrate sheet (22), a release layer (23) and the adhesive layer (24).

6. A process according to claim 1, wherein the ceramic green sheet (30) has a layer structure comprising the third substrate sheet (31), a release layer (32) and the dielectric layer (33).
